(19) United States
(12) Patent Application Publication
(10) Pub. No.: US 2026/0311496 A1
(43) Pub. Date: Oct. 8, 2026

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventor: Masaki TAKANO, Susono-shi (JP)

(73) Assignee: TOYOTA JIDOSHA KABUSHIKI KAISHA, Toyota-shi (JP)

(21) Appl. No.: 19/180,348

(22) Filed: Apr. 16, 2025

(30) Foreign Application Priority Data
Apr. 19, 2024 (JP) 2024-068298

(51) Int. Cl. G06V 20/56; G06V 10/70; G06V 10/98

(52) U.S. Cl. CPC G06V 20/588; G06V 10/70; G06V 10/993

(57) ABSTRACT

An information processing apparatus comprises a controller, the controller being configured to execute: performing first processing for recognizing a predetermined object based on an image acquired by an onboard camera included in a first vehicle; and performing second processing for improving recognition accuracy, for a first area among areas included in the image, the first area including at least a road area where the first vehicle is expected to travel.

### BACKGROUND

### Technical Field

The present disclosure relates to a vehicle technology.

### Description of the Related Art

There is a technology of generating road map data in real time while sensing road environments.

In relation thereto, for example, Japanese Patent Laid-Open No. 2016-194815 discloses an apparatus that performs weighting correction according to a travel environment, for an image recognition result, and recognizes road division lines based on a result of the correction.

### SUMMARY

An object of the present disclosure is to achieve both of road environment recognition accuracy and cost control.

The present disclosure in its one aspect provides An information processing apparatus comprising a controller, the controller being configured to execute: performing first processing for recognizing a predetermined object based on an image acquired by an onboard camera included in a first vehicle; and performing second processing for improving recognition accuracy, for a first area among areas included in the image, the first area including at least a road area where the first vehicle is expected to travel.

The present disclosure in its another aspect provides an information processing method executed by an information processing apparatus that is communicable with a first vehicle; the information processing method comprising: performing first processing for recognizing a predetermined object based on an image acquired by an onboard camera included in the first vehicle; and performing second processing for improving recognition accuracy, for a first area among areas included in the image, the first area including at least a road area where the first vehicle is expected to travel.

Further, as another aspect, a program for causing a computer to execute the above information processing method or a computer-readable storage medium that non-transitorily stores the program is given.

According to the present disclosure, it is possible to achieve both of road environment recognition accuracy and cost control.

### BRIEF DESCRIPTION OF THE DRAWINGS

FIG. 1 is a diagram for illustrating a problem in the present disclosure;

FIG. 2 is a diagram for illustrating the problem in the present disclosure;

FIG. 3 is a diagram illustrating a configuration of an onboard apparatus 10;

FIG. 4 is a diagram illustrating an overview of additional processing in a first embodiment;

FIG. 5 is a diagram illustrating a flow of data in the onboard apparatus 10;

FIG. 6 is a flowchart of a process executed by the onboard apparatus 10 in the first embodiment;

FIG. 7 is a diagram illustrating an overview of processing in a second embodiment;

FIG. 8 is a diagram illustrating the overview of processing in the second embodiment;

FIG. 9 is a flowchart of a process executed by the onboard apparatus 10 in the second embodiment;

FIG. 10 is a diagram illustrating an overview of processing in a modification of the second embodiment; and

FIG. 11 is a flowchart of a process executed by the onboard apparatus 10 in a third embodiment.

### DESCRIPTION OF THE EMBODIMENTS

Recently, research has been advanced on an autonomous travel system for a vehicle to autonomously travel along a route set in advance. In autonomous travel, a vehicle determines its position and posture by comparing a road map stored in advance and a result of sensing a road environment.

In such a system, however, a problem occurs that the road map has to be always kept up-to-date. For example, when a building or a construction along a road has been demolished, inconsistency with the road map occurs. Therefore, there is a possibility that the vehicle cannot correctly recognize its position. Further, when some lanes are closed due to construction or the like, a similar problem occurs. Though there is an approach of updating the road map based on information collected by probe cars, a time lag occurs, and it is not possible to completely solve the problem.

In order to cope therewith, a technology of traveling while recognizing a road environment in real time, without a road map being held on a vehicle side. For example, a vehicle holds only data for road directions and determines a line to travel on, based on a result of recognizing a road area (a travelable area) in real time. In this form, it is necessary to accurately determine the road area based on an image acquired by an onboard camera.

In order to accurately determine the road area, it is just necessary to increase resources assigned to image processing such as improving the resolution and improving the frame rate. An onboard apparatus, however, includes limited resources in comparison with a stationary computer. Therefore, a resource assignment method with a better cost performance is desired.

An information processing apparatus according to the present disclosure solves such a problem.

An information processing apparatus according to one aspect of the present disclosure includes a controller, the controller being configured to execute: performing first processing for recognizing a predetermined object based on an image acquired by an onboard camera included in a first vehicle; and performing second processing for improving recognition accuracy, for a first area among areas included in the image, the first area including at least a road area where the first vehicle is expected to travel.

The information processing apparatus according to the present disclosure may be an onboard apparatus mounted on the first vehicle, or may be a server apparatus that performs processing based on an image acquired by the first vehicle and provides information for the first vehicle.

The controller performs the first processing for recognizing a predetermined object based on an image acquired by the onboard camera. The predetermined object may be, for example, a road where the first vehicle is traveling. For example, the first vehicle can travel while recognizing an area (a road area) where the first vehicle can travel.

Further, the controller performs the second processing for improving recognition accuracy, for the first area in the image. The first area is an area that includes at least a road area where the first vehicle is expected to travel. The road area where the first vehicle is expected to travel may be any road area that the first vehicle is likely to travel on.

The second processing is additional processing for improving recognition accuracy. That is, the controller assigns more resources to an area where the first vehicle is likely to travel soon to perform recognition processing. In other words, for areas where the first vehicle is unlikely to travel, the controller does not perform the additional processing for improving recognition accuracy.

According to such a configuration, it is possible to assign additional resources to a more important area in the image.

The first area may include at least an area that is away from the first vehicle by a distance with a predetermined value or more.

Since the resolution of an area that is away from the first vehicle by a distance with a predetermined value or more is low in comparison with other areas, the recognition accuracy can be said to be relatively low. Therefore, by performing the additional processing for such an area, the whole recognition accuracy can be improved.

Further, the controller may determine the first area in the image based on a scheduled route of the first vehicle.

The scheduled route of the first vehicle may be determined, for example, based on information acquired from a navigation apparatus or a control device in charge of autonomous travel. Thereby, it is possible to determine where the first vehicle is heading in the image and appropriately determine the first area.

Further, the controller may determine the first area in the image based on vehicle data acquired from the first vehicle.

The vehicle data is data showing, for example, the state and behavior of the vehicle. The vehicle data may include a steering angle and data showing the operation state of a direction indicator. The controller can estimate the scheduled route of the first vehicle based on such data.

Further, the controller may set the first area such that a second road area corresponding to a lane where a second vehicle located near the first vehicle is traveling is included.

There may be a case where improvement of recognition accuracy is required not only for a lane where the first vehicle is traveling but also for a lane where another vehicle located near the first vehicle is traveling. Therefore, the first area may be set such that the lane where the second vehicle is traveling is included.

As the second processing, for example, processing for which resources for image recognition are increased more than the firsts processing can be exemplified. For example, forms of “executing recognition processing without downsampling the resolution” and “executing recognition processing without thinning out the frame rate” can be exemplified.

Further, when the first processing is processing executed using a machine learning model, processing for relearning the machine learning model may be executed as the second processing.

For example, when image recognition is performed at each time step, it becomes possible to, as an object included in the first area approaches the first vehicle, more accurately recognize the object. Therefore, a recognition result obtained at a later time step may be used as teacher data for input data at a previous time step to cause the machine learning model to be relearned. Thereby, it is possible to improve the accuracy of recognition of the object.

Further, the second processing may be processing for correcting a result of recognizing the road area included in the first area, using information sources that have not been used in the first processing.

For example, processing for correcting the result of recognizing the road area included in the first area, using data output by a sensor other than an image sensor (for example, a radar or LiDAR), data received from the outside of the vehicle, or the like may be set as the second processing.

Embodiments of the present disclosure will be described below based on the drawings. Configurations of the embodiments below are examples, and the present disclosure is not limited to the configurations of the embodiments.

### First Embodiment

An overview of a vehicle system according to a first embodiment will be described. The vehicle system according to the present embodiment includes a vehicle 1, an onboard apparatus 10 mounted on the vehicle 1, and a camera 20 mounted on the vehicle 1.

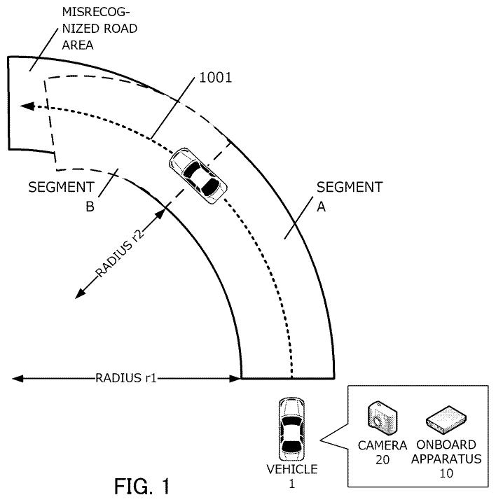

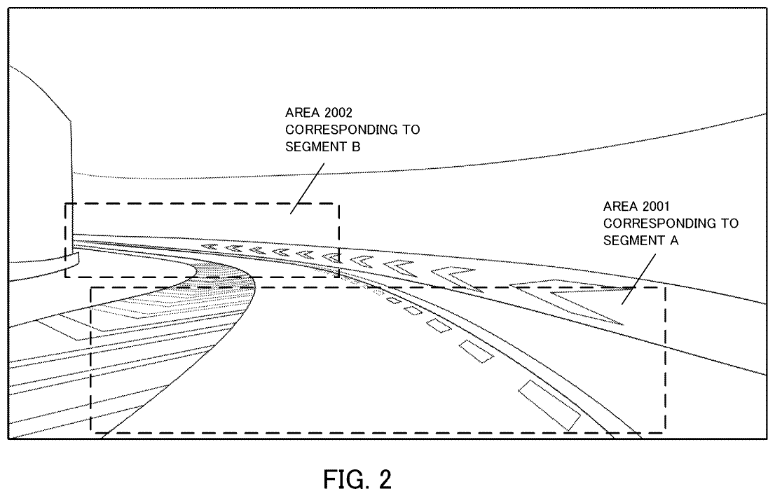

A problem solved by the system will be described with reference to FIGS. 1 and 2.

The onboard apparatus 10 mounted on the vehicle 1 recognizes a road area around the vehicle 1 based on an image captured by the camera 20 and executes control for causing the vehicle 1 to autonomously travel using a recognition result.

The onboard apparatus 10 stores data for road directions to a destination (directions data), and the vehicle 1 travels according to the directions data along the recognized road area.

The road area is typically an area where the vehicle 1 can travel. The road area can be recognized by detecting boundaries (road edges) of a road, but a recognition target is not limited to road edges. For example, a lane border line, a lane centerline, a road centerline, or the like may be a recognition target.

In the example of FIG. 1, there are two road segments (segments A and B) including curves, and it is assumed that the vehicle 1 travels on the road segments. The segment A is a curve with a radius r1, and a segment B is a curve with a radius r2. Here, it is assumed that r2 is smaller than r1. That is, the segment B has a curve sharper than that of the segment A.

FIG. 2 illustrates an example of an image captured by the camera 20 of the vehicle 1 immediately before the vehicle 1 enters the illustrated curve. The image includes both of the segments A and B.

As for an area far from the vehicle 1, however, the recognition accuracy tends to deteriorate in comparison with an area in the foreground because of the low image resolution. For example, there may be a case where, at the illustrated timing, the onboard apparatus 10 recognizes that “a curve with the radius r1 continues (that both of the segments A and B have the radius r1”. In this case, the onboard apparatus 10 generates a travel trajectory on the assumption that “the curve with the radius r1 continues” as indicated by reference sign 1001 in FIG. 1.

Actually, however, the radius of the curve of the segment B is smaller than that of the segment A. Since the image resolution of a nearer road area is higher, it becomes possible for the onboard apparatus 10 to correctly recognize the curve radius of the segment B as the vehicle 1 travels forward. Therefore, there may be a case where, as a result of the travel trajectory indicated by reference sign 1001 being modified during travel, the turn rate suddenly changes in the middle of the curve. It is not favorable for travel stability of the vehicle.

Therefore, the onboard apparatus 10 according to the present embodiment executes additional processing for improving recognition accuracy (hereinafter, the additional processing) for an area far from the vehicle 1 (for example, an area 2002 in FIG. 2). By partially executing the additional processing as described above, it is possible to improve the recognition accuracy, minimizing increase in costs.

### Apparatus Configuration

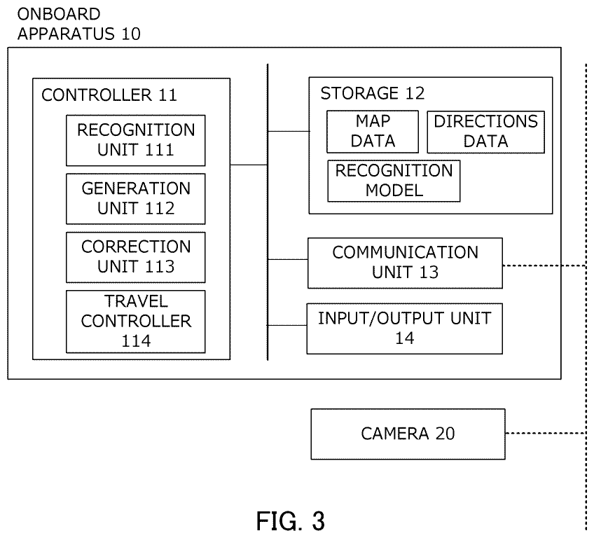

FIG. 3 is a diagram illustrating an example of a configuration of the vehicle 1.

The onboard apparatus 10 can be configured as a computer that includes a processor (a CPU, a GPU, or the like), a main storage device (a RAM, a ROM, and the like), an auxiliary storage device (an EPROM, a hard disk drive, a removable medium, or the like). In the auxiliary storage device, an operating system (OS), various kinds of programs, various kinds of tables, and the like are stored. By executing a program stored therein, such functions (software modules) fitting for predetermined purposes as described later can be realized. A part or all of the functions, however, may be realized as hardware modules by a hardware circuit such as an ASIC or an FPGA.

The onboard apparatus 10 includes a controller 11, a storage 12, a communication unit 13, and an input/output unit 14.

The controller 11 is an arithmetic unit that realizes the various functions of the onboard apparatus 10 by executing a predetermined program. The controller 11 can be realized, for example, by a hardware processor such as a CPU. Further, the controller 11 may include a RAM, a ROM (read-only memory), and a cache memory.

The controller 11 includes four software modules of a recognition unit 111, a generation unit 112, a correction unit 113, and a travel controller 114. Each software module may be realized by executing a program stored in the storage 12 to be described later by the controller 11 (such as a CPU).

The recognition unit 111 acquires an image from the camera 20 to be described later and recognizes a road area included in the image. In the present embodiment, the recognition unit 111 converts the acquired image to a feature and inputs the obtained feature to a machine learning model stored in the storage 12. The machine learning model is a model specialized in recognizing a road area (hereinafter, a recognition model). Thereby, it is possible to estimate the road area in the image.

A result of recognizing the road area is transmitted to the generation unit 112.

The generation unit 112 generates map data based on the result of recognizing the road area performed by the recognition unit 111. The map data is a two-dimensional or three-dimensional map showing a travelable area (a road area) in space where the vehicle 1 is located. The generation unit 112 identifies the travelable area (the road area) in the space based on the recognition result received from the recognition unit 111 and generates data indicating the identified road area (road area data). Further, the generation unit 112 generates map data which is a set of pieces of road area data. The map data may be erased each time, or the map data generated once may be stored to be reused.

In the present embodiment, the additional processing for improving accuracy may be performed for a road area that has been recognized once. That is, map data that has been generated once may be updated as the vehicle travels.

For a road area that has been recognized once, the correction unit 113 executes the additional processing for improving accuracy. As described before, the resolution of a road area in the distance is low, and the resolution of a road area nearby is high. That is, the recognition accuracy of a road area in the distance is low at first, and the recognition accuracy is gradually improved as the vehicle 1 travels forward. In other words, a correct answer for a result of recognizing a road area at a certain time step may be revealed at a later time step.

Therefore, the correction unit 113 relearns the machine learning model for recognizing a road area at a timing when a target road area approaches the vehicle 1.

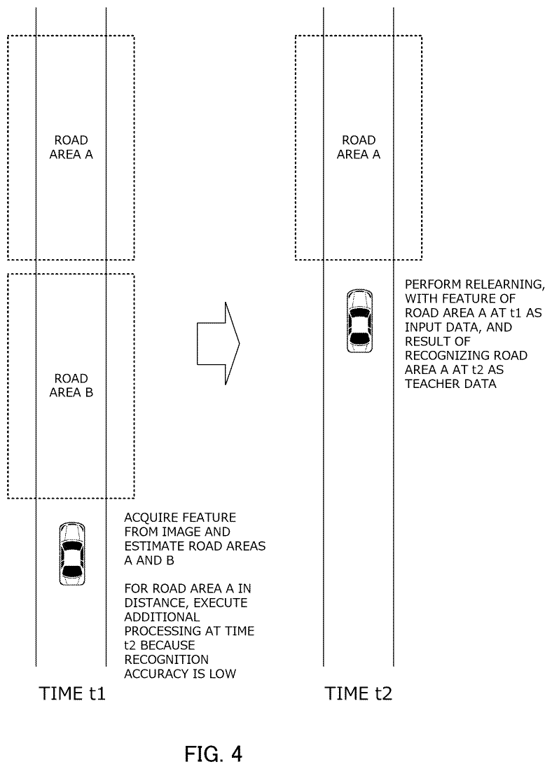

FIG. 4 is a diagram illustrating the processing.

It is assumed that, at time t1 in the diagram, there is a road area B near the vehicle, and there is a road area A in the distance. It is assumed that the recognition model held by the onboard apparatus 10 separately recognizes each of the road area A in the distance and the road area B nearby. In the present embodiment, a distant area refers to an area that includes a road area where the vehicle 1 is expected to travel soon and is an area away from the vehicle 1 by a distance with a predetermined value or more. Here, since the road area B is nearer to the vehicle 1, the recognition accuracy thereof is higher than that of the road area A.

When the vehicle 1 travels forward, and time t2 comes, it becomes possible for the onboard apparatus 10 to more accurately recognize the road area A. In the present embodiment, the correction unit 113 performs relearning of the recognition model at this timing.

Specifically, a result of recognizing the road area A at the time t2 (that is, a recognition result with a higher accuracy) is treated as a correct answer for a feature used for recognition at the time t1. That is, the recognition model is relearned, with the feature corresponding to the road area A at the time t1 as input data, and the recognition result at the time t2 as teacher data.

The travel controller 114 controls autonomous travel of the vehicle 1 based on generated map data. The travel controller 114 detects obstacles around the vehicle based on an image captured by the camera 20, and controls autonomous travel of the vehicle using both of data obtained as a result of the detection (hereinafter, environment data) and the generated map data. The environment data is, for example, data showing the number and positions of vehicles present around the vehicle 1, the number and positions of obstacles (for example, pedestrians, bicycles, structures, and buildings) present around the vehicle 1, and the like but is not limited thereto. The detection target may be anything that is necessary to detect in order to perform autonomous travel.

The environment data is generated by processing different from the road area recognition processing.

The travel controller 114 causes the vehicle 1 to travel such that the vehicle 1 travels along a route shown by directions data, and an obstacle does not enter a predetermined safe area around the vehicle 1. As a method for causing the vehicle to autonomously travel, a publicly known method can be adopted. The directions data is data for providing road directions and is typically information for informing right and left turn positions existing and interchanges to be used before reaching a destination, and the like.

The storage 12 is means for storing information and includes a storage medium such as a RAM, a magnetic disk, or a flash memory. In the storage 12, the program to be executed by the controller 11, data used by the program, and the like are stored.

In the storage 12, the map data, directions data, and recognition model described above, and the like are stored.

The communication unit 13 is a wireless communication interface for connecting the onboard apparatus 10 to an in-vehicle network.

The input/output unit 14 is a unit that accepts an input operation performed by a passenger of the vehicle and presents information for the passenger. In the present embodiment, the input/output unit 14 includes one touch panel display. That is, the input/output unit 14 includes a liquid crystal display, control means for the liquid crystal display, a touch panel, and control means for the touch panel.

As for a specific hardware configuration of the onboard apparatus 10, it is possible to appropriately omit, replace, and add components according to an embodiment. For example, the controller 11 may include a plurality of hardware processors. Each hardware processor may include a microprocessor, an FPGA, and a GPU. Further, an input/output device (for example, an optical drive) other than those exemplified above may be added. Further, the onboard apparatus 10 may include a plurality of computers. In this case, hardware configurations of the computers may be the same or may be different.

### Details of Additional Processing

Next, details of the additional processing executed by the correction unit 113 will be described.

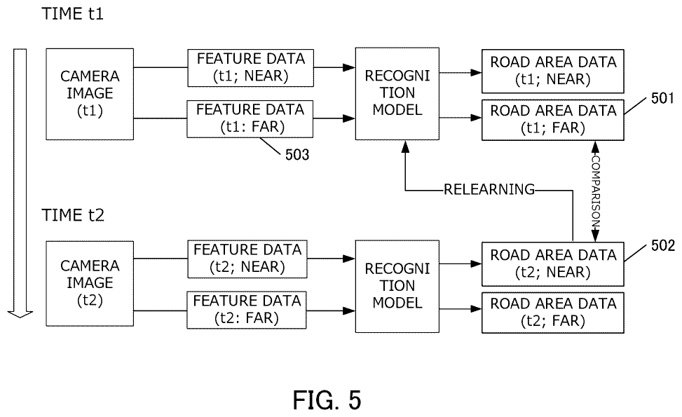

FIG. 5 is a chart illustrating a flow of data at the time of the onboard apparatus 10 relearning the recognition model, in more detail.

First, at the time t1, an image (referred to as a camera image) is acquired from the camera 20. The recognition unit 111 converts the camera image to a feature and recognizes a road area using the recognition model. At this time, the recognition unit 111 divides the feature for a road area located near the vehicle 1 (hereinafter referred to as a near area) and a road area away from the vehicle 1 by a distance with a predetermined value or more (hereinafter referred to as a far area) and performs road area recognition individually for each of the areas. Though the near and far areas can be set in any positions in the image, it is assumed that each of the near and far areas includes a road area where the vehicle 1 is expected to travel soon and that the near area is located nearer to the vehicle 1. For example, the recognition unit 111 may recognize a lane where the vehicle 1 is traveling first and then set the near and far areas on the lane. For example, in the example of FIG. 2, reference signs 2001 and 2002 can indicate the near area and far area, respectively.

As a result, data including a recognition result (road area data) is generated for each of the near and far areas.

Next, a consideration will be made on a case where the vehicle continues traveling, and the time t2 comes. In this example, it is assumed that the time t2 is a timing when the road area located far from the vehicle 1 at the time t1 comes near the vehicle 1.

At the time t2, the recognition unit 111 similarly executes road area recognition for each of the near and far areas. Here, it is assumed that a result of recognizing the near area at the time t2 (reference sign 502) and a result of recognizing the far area at the time t1 (reference sign 501) are results of recognizing the same road area. Actually, however, the recognition accuracy of the road area data indicated by reference sign 501 is lower. Therefore, the correction unit 113 compares both of the road area data indicated by reference sign 501 and the road area data indicated by reference sign 502, and, if a difference is equal to or larger than a predetermined value, executes relearning of the recognition model.

The relearning is executed, with a feature corresponding to the far area at the time t1 (reference sign 503) as input data, and the recognition result at the time t2 (reference sign 502) as teacher data. Thereby, it is possible to improve the capability of the recognition model recognizing the far area at the time t1.

Whether or not to execute relearning may be dynamically determined based on the result of comparing the road area data indicated by reference sign 501 and the road area data indicated by reference sign 502. For example, an amount of difference in the shape, the area, the curve radius, or the like between the road areas obtained by a result of recognition is equal to or larger than a predetermined value, it may be determined that relearning is necessary.

Even when the amount of difference of the recognition result is large, relearning may not be executed if there is no travel safety risk.

### Process Flow

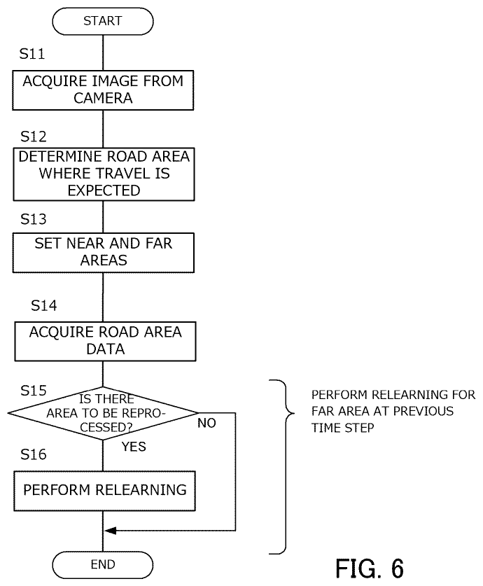

Next, a flow of a process executed by the onboard apparatus 10 will be described. FIG. 6 is a flowchart of the process executed by the onboard apparatus 10. The illustrated process is cyclically executed while the vehicle 1 is traveling.

First, at step S11, the recognition unit 111 acquires an image from the camera 20.

Next, at step S12, the recognition unit 111 determines a road area where the vehicle 1 is expected to travel, in the image. The road area where the vehicle 1 is expected to travel can be determined, for example, based on information as below:
A lane where the vehicle 1 is traveling, which has been determined by image recognition
Position information acquired by a GPS module
A travel direction (a head direction) acquired from a gyrosensor
A steering angle

The recognition unit 111 can determine the road area where the vehicle 1 is expected to be headed soon, in the image, based on a combination of the above pieces of information.

The recognition unit 111 may estimate that the vehicle 1 will change its travel course within a predetermined period, based on information other than the above. For example, when a direction indicator of the vehicle 1 is operating, the recognition unit 111 may estimate that the vehicle 1 will change the lane in a direction indicated by the direction indicator within the predetermined time. Such a determination may be made, for example, based on CAN data that flows through the in-vehicle network. The above pieces of data are examples of the “vehicle data”.

Next, at step S13, the recognition unit 111 sets near and far areas in the image acquired from the camera 20. Both of the near and far areas are set in the road area where the vehicle 1 is expected to travel soon. For example, both of the near and far areas can be areas that include the lane where the vehicle 1 is currently traveling. For example, the recognition unit 111 may recognize the lane where the vehicle 1 is traveling and then set the near and far areas on the lane. For example, in the example of FIG. 2, reference signs 2001 and 2002 indicate the near area and the far area, respectively.

The near area is an area where the road area is recognized by ordinary processing, and the far area is an area where the additional processing is also performed in addition to the ordinary processing. Therefore, it is preferable that the far area is set in an area where the recognition accuracy is assumed to be low. For example, the far area can be an area far from the vehicle 1 by a predetermined distance or more with a relatively low resolution.

By setting the near and far areas at this step, data including a recognition result (road area data) is generated for each of the near and far areas.

Next, at step S14, the recognition unit 111 recognizes the road area for a processing target area, and generates road area data which is a result of the recognition. The road area data can be data that indicates an area where the vehicle 1 can travel (the road area) in two-dimensional or three-dimensional space. When the processing target area is divided in near and far areas, the recognition unit 111 generates the road area data for each of them.

Next, at step S15, the correction unit 113 determines whether there is an area to be reprocessed, between the road areas processed at step S15. The area to be reprocessed is an area for which the additional processing for improving recognition accuracy is to be executed. For example, as described with reference to FIGS. 4 and 5, it is possible to, when the accuracy of road area recognition performed for a far area at a previous time step is low, determine that reprocessing is to be performed for the road area at a current time step. It is possible to determine that the accuracy of the road area recognized at the previous time step is low, by comparing pieces of road area data corresponding to the same road area at different time steps, for example, like reference signs 501 and 502 of FIG. 5.

When there is not an area for which the recognition accuracy is determined to be low or an area that has a safety problem due to its low recognition accuracy, the correction unit 113 may determine that “there is no area to be reprocessed”.

If it is determined that there is an area to be reprocessed, at step S15, the process transitions to step S16, where the correction unit 113 executes relearning for the target area. At step S16, relearning of the recognition model is performed, for example, with a feature (reference sign 503) used for estimation at a past time step as input data, and a road area recognition result (reference sign 502) at a current time step as teacher data.

As described above, the onboard apparatus 10 according to the first embodiment performs the additional processing for improving recognition accuracy, for an area that includes at least a road area where the vehicle 1 is expected to travel, among areas included in an image acquired by the onboard camera. In other words, for a road area where the vehicle 1 is unlikely to travel, the processing for improving recognition accuracy is not performed. Thereby, it is possible to improve recognition accuracy, minimizing increase in costs.

### Second Embodiment

In the first embodiment, recognition accuracy is improved by performing relearning of the recognition model at step S16. That is, the additional processing is processing for causing the recognition model to be relearned, using both of data acquired at a past time step and data acquired at a current time step.

The additional processing, however, may be processing for improving recognition accuracy, using only data that has been obtained at a current time step.

The onboard apparatus 10 according to a second embodiment is an embodiment in which a road area where the vehicle 1 is expected to travel is determined from a camera image, and more processing resources are assigned to the road area in real time.

Here, a method for determining a road area where the vehicle 1 is expected to travel will be additionally exemplified.

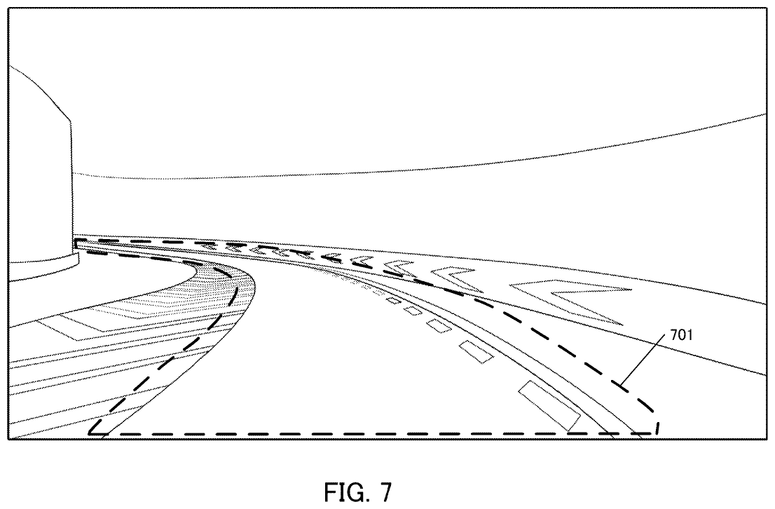

The first is a method of estimating a travel course of the vehicle 1 and then determining the “area where the vehicle 1 is expected to travel” using a result of the estimation. For example, when the vehicle 1 is traveling on such a lane that the travel course cannot be changed, it can be estimated that “the vehicle 1 continues traveling on the same lane”. In this case, for example, an area indicated by reference sign 701 in FIG. 7 can be regarded as the area where the vehicle 1 is expected to travel.

Further, for example, when it is determined that the vehicle 1 will change the lane within a predetermined period, based on route information acquired in advance or vehicle information acquired during travel in real time (for example, an operation situation of a direction indicator), an area corresponding to an adjoining lane may be regarded as the area where the vehicle 1 is expected to travel. The route information may be acquired from the navigation apparatus or the like or may be acquired from an ECU or the like that controls autonomous travel or semi-autonomous travel.

The second is a method of dividing an area included in a camera image into an area where the vehicle 1 is likely to travel and an area where the vehicle 1 is unlikely to travel, and treating the area where the vehicle 1 is likely to travel as the “area where the vehicle 1 is expected to travel”.

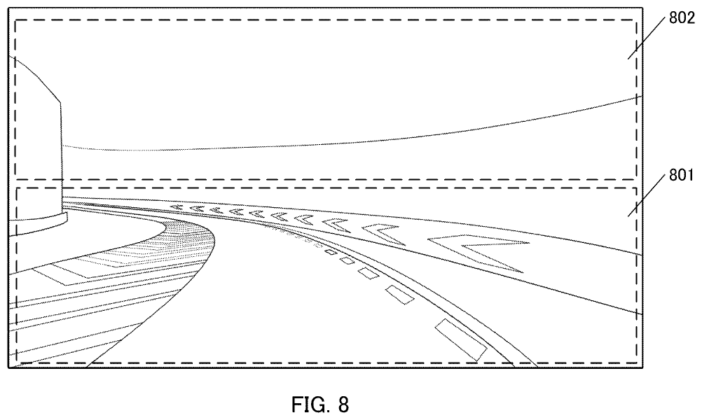

FIG. 8 is a diagram for illustrating this method. In the illustrated example, an image captured by the onboard camera is divided in an area indicated by reference sign 801 and an area indicated by reference sign 802. Between the areas, the area indicated by reference sign 802 is an area where the vehicle 1 never travels, and, therefore, it does not matter if the recognition accuracy is low. Thus, an area included in a camera image may be divided into an area where the vehicle 1 is likely to travel and an area the vehicle 1 is unlikely to travel, and the former may be treated as the area where the vehicle 1 is expected to travel.

Further, in the second embodiment, the correction unit 113 executes the additional processing in real time.

For example, when the frame rate of an image output by the camera is 60 frames per second, it is possible to “perform recognition processing at 30 frames per second for the area 802 and perform recognition processing at 60 frames per second for the area 801”. Further, when the resolution of an image output by the camera is downsampled, it is possible to “perform recognition processing after downsampling, for the area 802, and perform recognition processing without performing downsampling, for the area 801”.

Further, the correction unit 113 may correct a road area recognition result, using information other than a camera image. For example, the correction unit 113 may perform processing for correcting a recognition result, using a sensor other than an onboard image sensor.

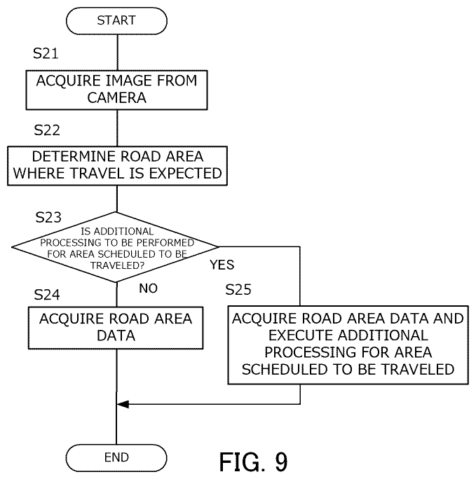

FIG. 9 is a flowchart of a process executed by the onboard apparatus 10 in the second embodiment. The illustrated process is cyclically executed while the vehicle 1 is traveling.

First, at step S21, the recognition unit 111 acquires an image from the camera 20.

Next, at step S22, the recognition unit 111 determines a road area where the vehicle 1 is expected to travel, in the image. The road area where the vehicle 1 is expected to travel can be determined by a method similar to that of step S12. The road area where the vehicle 1 is expected to travel is a road area for which the recognition accuracy is to be improved.

In the description below, the road area where the vehicle 1 is expected to travel will be referred to as “an area scheduled to be traveled”, and other areas will be referred to as “areas not to be traveled”.

Next, at step S23, it is determined whether or not to perform recognition accuracy improvement for the area scheduled to be traveled. For example, when it is desirable to take a sufficient margin for safety, because of a lot of traffic, it is desirable to perform recognition accuracy improvement for the area scheduled to be traveled. Further, when the likelihood (reliability) output by the recognition model is equal to or below a predetermined value, it is desirable to perform recognition accuracy improvement.

When a negative determination is made at the present step, the process transitions to step S24. When a positive determination is made at the present step, the process transitions to step S25.

At step S24, the recognition unit 111 recognizes the road area for the processing target area by processing similar to that of step S14, and generates road area data, which is a result of the recognition. In the present embodiment, since the processing target area is not divided in near and far areas, the recognition unit 111 generates a single piece of road area data.

At step S25, the additional processing for improving recognition accuracy is executed for the area scheduled to be traveled, in addition to the processing described at step S24. The additional processing may be processing for recognizing the road area by an approach different from that of the processing performed at step S24 and, based on a result thereof, correcting the recognition result.

Further, the additional processing may be processing for correcting the road area recognition result using information sources not used at step S24. For example, when messages transmitted from surrounding vehicles, messages transmitted from roadside apparatuses, and the like can be used, the processing for correcting the recognition result may be performed, with the messages as additional information sources. Further, the processing for correcting the recognition result may be performed based on data output from a sensor other than the onboard camera.

In any of the cases, additional resources for recognizing the road area are assigned to the area scheduled to be traveled, in comparison with other areas.

As described above, in the second embodiment, a road area where the vehicle 1 is expected to travel and other areas are separated, and the additional processing for improving recognition accuracy is performed for the road area where the vehicle 1 is expected to travel. Thereby, it becomes possible to assign resources for improving road area recognition accuracy only to an area where the vehicle 1 is likely to travel.

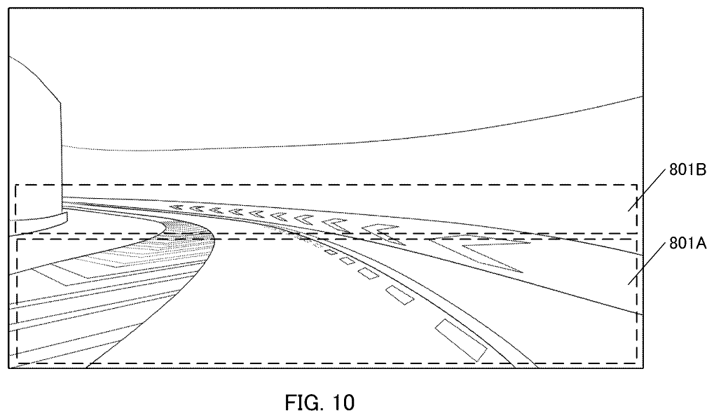

In the example of FIG. 8, the additional processing is performed for the whole area where the vehicle 1 is likely to travel (the area 801). The additional processing, however, may be performed only for an area with a relatively low recognition accuracy. For example, as illustrated in FIG. 10, the area where the vehicle 1 is likely to travel can be divided into an area nearer to the vehicle 1 (an area 801A) and an area farther from the vehicle 1 (an area 801B). The area 801A is an area for which recognition can be performed with a predetermined accuracy, without performing the additional processing. In comparison, the area 801B is an area with recognition accuracy lower than that of the area 801A. In such a case, the onboard apparatus 10 may execute the additional processing only for the area 801B located in the distance. Thereby, it is possible to save resources required for the additional processing.

### Third Embodiment

In the first and second embodiments, the additional processing for improving recognition accuracy is performed only for a road area where the vehicle 1 is expected to travel (an area scheduled to be traveled). A road area for which it is beneficial to improve recognition accuracy, however, is not limited to a lane where the vehicle 1 travels. For example, in a case where another vehicle is traveling in parallel on an adjoining lane, the additional processing for increasing recognition accuracy may be performed for the lane where the other vehicle is traveling. Thereby, for example, it becomes possible to accurately estimate behavior of the other vehicle.

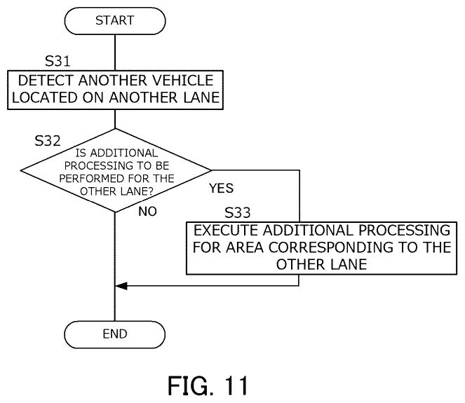

In the third embodiment, the onboard apparatus 10 recognizes another vehicle located near the vehicle 1 and executes the additional processing for a road area corresponding to a lane where the other vehicle is traveling (a second road area), in addition to the processing described in the first and second embodiments. FIG. 11 is a flowchart of the process. The illustrated flowchart is executed after the process illustrated in FIG. 6, after the process illustrated in FIG. 9, or at any timing.

First, at step S31, the recognition unit 111 detects presence of another vehicle that is traveling on a lane other than a lane where the vehicle 1 is traveling. Presence of another vehicle may be detected via the camera 20 or may be detected using an onboard sensor other than the camera (for example, an ultrasonic sensor or a LiDAR).

Next, at step S32, the correction unit 113 determines whether or not to execute the additional processing for the lane where the detected other vehicle is traveling. For example, when there are sufficient resources of the onboard apparatus 10 or when it is preferable to more accurately expect behavior because the position of the other vehicle is near the vehicle 1, a positive determination is made at the present step.

When a positive determination is made at step S32, the process transitions to step S33, and the recognition unit 111 executes the additional processing for an area corresponding to the lane where the detected other vehicle is traveling. When a negative determination is made at step S32, the process ends.

According to the third embodiment, the additional processing for increasing recognition accuracy is performed for a lane where another vehicle is traveling. Thereby, an advantageous effect is obtained that it becomes possible to accurately expect behavior of the other vehicle is obtained.

The onboard apparatus 10 may detect all other vehicles from an image acquired by the camera 20 and execute the additional processing for all lanes where the other vehicles are present.

### Other Embodiments

The above embodiments are mere examples, and the present disclosure can be appropriately changed within a range not departing from the spirit thereof and implemented.

For example, the processes and means described in the present disclosure may be freely combined and implemented as far as no technical contradictions occur.

Further, though the example of the onboard apparatus 10 recognizing a road area is given in the description of the embodiments, recognition of a road area may be performed by a server apparatus installed at a place different from the vehicle. In this case, a camera image may be transmitted from the onboard apparatus to the server apparatus, and a result of recognizing a road area may be transmitted from the server apparatus to the onboard apparatus.

Further, though a road itself is exemplified as a recognition target in the description of the embodiments, the recognition target does not necessarily have to be a road itself. For example, an object on a road, an object moving on a road, or the like may be a recognition target.

Further, in the description of the embodiments, a road area where the vehicle 1 is expected to travel is determined, and the additional processing is performed for the road area. A road area targeted by the additional processing, however, may be any area where the vehicle 1 is likely to travel and does not necessarily have to be an area where the vehicle 1 is expected to travel. For example, even if a direction indicator is not operating, the additional processing may be performed for a lane adjoining to a lane where the vehicle 1 is traveling.

Further, a process described as being performed by one apparatus may be shared and executed by a plurality of apparatuses. Or alternatively, processes described as being performed by different apparatuses may be executed by one apparatus. In a computer system, what hardware configuration (server configuration) each function is realized by can be flexibly changed.

The present disclosure can be realized by supplying a computer program implemented with the functions described in the above embodiments to a computer, and one or more processors included in the computer reading out and executing the program. Such a computer program may be provided for the computer by a non-transitory computer-readable storage medium connectable to a system bus of the computer or may be provided for the computer via a network. As the non-transitory computer-readable storage medium, for example, any type of disk/disc such as a magnetic disk (a floppy (registered trademark) disk, a hard disk drive ((HDD), or the like) and an optical disc (a CD-ROM, a DVD disc, a Blu-ray disc, or the like), a read-only memory (ROM), a random-access memory (RAM), an EPROM, an EEPROM, a magnetic card, a flash memory, an optical card, and any type of medium that is appropriate for storing electronic commands are included.

What is claimed is:

1. An information processing apparatus comprising a controller, the controller being configured to execute:
performing first processing for recognizing a predetermined object based on an image acquired by an onboard camera included in a first vehicle; and
performing second processing for improving recognition accuracy, for a first area among areas included in the image, the first area including at least a road area where the first vehicle is expected to travel.

2. The information processing apparatus according to claim 1, wherein
the first area includes at least an area that is away from the first vehicle by a distance with a predetermined value or more.

3. The information processing apparatus according to claim 1, wherein
the controller determines the first area in the image based on a scheduled route of the first vehicle.

4. The information processing apparatus according to claim 1, wherein
the controller determines the first area in the image based on vehicle data acquired from the first vehicle.

5. The information processing apparatus according to claim 1, wherein
the controller sets the first area such that a second road area corresponding to a lane where a second vehicle located near the first vehicle is traveling is included.

6. The information processing apparatus according to claim 1, wherein
the second processing is processing in which resources for image recognition have been increased for the first processing.

7. The information processing apparatus according to claim 1, wherein
the first processing is processing executed using a machine learning model; and
the second processing is processing for relearning the machine learning model at a timing when an object included in the first area approaches the first vehicle.

8. The information processing apparatus according to claim 1, wherein
the first processing is processing for recognizing a road area; and
the second processing is processing for correcting a result of recognizing the road area included in the first area, using information sources that have not been used in the first processing.

9. An information processing method executed by an information processing apparatus that is communicable with a first vehicle; the information processing method comprising:
performing first processing for recognizing a predetermined object based on an image acquired by an onboard camera included in the first vehicle; and
performing second processing for improving recognition accuracy, for a first area among areas included in the image, the first area including at least a road area where the first vehicle is expected to travel.

10. The information processing method according to claim 9, wherein
the first area includes at least an area that is away from the first vehicle by a distance with a predetermined value or more.

11. The information processing method according to claim 9, wherein
the first area in the image is determined based on a scheduled route of the first vehicle.

12. The information processing method according to claim 9, wherein
the first area in the image is determined based on vehicle data acquired from the first vehicle.

13. The information processing method according to claim 9, wherein
the first area is set such that a second road area corresponding to a lane where a second vehicle located near the first vehicle is traveling is included.

14. The information processing method according to claim 9, wherein
the second processing is processing in which resources for image recognition have been increased for the first processing.

15. The information processing method according to claim 9, wherein
the first processing is processing executed using a machine learning model; and
the second processing is processing for relearning the machine learning model at a timing when an object included in the first area approaches the first vehicle.

16. The information processing method according to claim 9, wherein
the first processing is processing for recognizing a road area; and
the second processing is processing for correcting a result of recognizing the road area included in the first area, using information sources that have not been used in the first processing.

17. A non-transitory storage medium with a program recorded therein, the program being for causing a computer to execute the information processing method according to claim 9.
